(19) United States
(12) Patent Application Publication
(10) Pub. No.: US 2004/0083015 A1
(43) Pub. Date: Apr. 29, 2004

(54) System for multimedia rendering in a portable device

(76) Inventor: Srinivas Patwari, San Diego, CA (US)

Correspondence Address: Qualcomm Incorporated, Patents Department, 5775 Morehouse Drive, San Diego, CA, 92121-1714, US

(21) Appl. No.: 10/453,091

(22) Filed: Jun. 2, 2003

Related U.S. Application Data
(60) Provisional application No. 60/385,942, filed on Jun. 4, 2002.

(51) Int. Cl. G06F 17/00

(52) U.S. Cl. 700/90

(57) ABSTRACT

A multimedia system for rendering multimedia content in a portable device having an embedded processor. The portable device includes one or more rendering resources. A method is provided that performs operations of generating a multimedia object based on the multimedia content, associating a format handler with the multimedia object, and controlling a selected rendering resource using the format handler to render the multimedia content from the multimedia object.

### CROSS REFERENCE TO RELATED APPLICATIONS

This Application claims the benefit of priority from co-pending U.S. Provisional Patent Application Serial No. 60/385,942 entitled “Multimedia Processing” filed on Jun. 4, 2002. This Application also claims the benefit of priority from co-pending U.S. Provisional Application entitled “Multimedia Processing” filed on Apr. 25, 2003. The disclosures of both of the above-identified Provisional Applications are incorporated by reference herein in their entirety for all purposes.

### BACKGROUND

I. Field

The present invention relates generally to multimedia processing, and more particularly, to a system for multimedia rendering in a portable device having an embedded controller.

II. Description of the Related Art

Advances in technology have resulted in smaller and more powerful personal computing devices. For example, there currently exist a variety of portable cellular telephones, personal digital assistants (PDAs), and paging devices that are small, lightweight, and can be easily carried by users. Typically, these devices include an embedded controller with limited memory resources. For example, the amount of available memory may be limited by the small size of the device.

However, there is an increasing need for these devices to handle larger amounts of data and to execute programs that are more sophisticated. For example, users are demanding remote access to interactive programs, such as gaming programs, that require the portable device to provide fast and efficient rendering of multimedia applications and content. For example, users would like to use their portable devices to view and hear multimedia content, such as video clips, animations, movies, and audio, such as music content provided in MP3 format.

In order to render multimedia content on a portable device, it is necessary to control the rendering resources of the device. For example, one type of portable device may include a small low-resolution display screen or an audio speaker, and another type of portable device may include a larger and higher-resolution display and two-speaker stereo capabilities. Thus, each type of portable device may have different multimedia rendering resources with which to render multimedia content. Therefore, compatibility problems have to be overcome when providing multimedia content for use on a wide variety of portable devices having various configurations and rendering resources.

One technique used to overcome compatibility problems requires that the multimedia content be in a format that is specifically compatible with the rendering resources available on the portable device. For example, if a content developer wishes to produce video content for use on a specific portable device, the developer tailors the video content to be exactly compatible with the video rendering resources available on the portable device.

Unfortunately, it is expensive and inefficient to produce multimedia content that is tailored for each portable device that the content is to be rendered on. For example, a content developer would need to modify the content for different portable devices, and thereby generate multiple versions of the same content. Also, the content developer would have to constantly update its content as new rendering resources become available.

Therefore, what is needed is a system that allows multimedia content to be rendered on a variety of portable devices without having to tailor the content to account for different rendering resources available on each device. The system should operate to allow all types of multimedia content to be rendered and provide an extensible architecture that allows for the rendering of new multimedia formats as they are developed.

### SUMMARY

In one or more embodiments, a multimedia system, including methods and apparatus, is provided for rendering multimedia content on a portable device. For example, the portable device may be a cellular telephone with an embedded controller and limited memory resources that executes program instructions to render multimedia content using the available rendering resources of the device. In one or more embodiments, the multimedia system is a small and efficient implementation that uses few resources and is particularly well suited for use in portable devices having embedded controllers with limited memory resources.

In one embodiment, the system comprises a collection of format handlers to control the rendering resources of the device. Each format handler is designed to process multimedia content having a specific format, and thereby control the rendering resources of the device to render that content. For example, each format handler renders (a specifically formatted) multimedia audio or video file (plays and understands it). The format handler determines what resources the content needs, reads the file, and calls the correct resources. The portable device includes a high level application program interface (API) that the format handler uses to perform the task. Each format handler can be included as part of the multimedia system in the portable device at manufacture, or can be downloaded dynamically. It is therefore possible for one or more embodiments of the multimedia system to utilize a collection of format handlers, and thereby operate to render multimedia content in a variety of portable devices without having to tailor the content based on the rendering resources available at each device. Additionally, the multimedia system provides an extensible architecture that allows the system to be expanded by adding new format handlers to render new content types as they are developed.

The architecture of the multimedia system is beneficial to both multimedia users and developers. For example, it allows developers to write their own format handlers for use on a wireless platform. And multimedia users benefit because the system provides a simple interface to allow all types of content to be rendered without having to know the exact configuration of the rendering device.

In one embodiment, a method is provided for rendering multimedia content in a portable device having an embedded processor. The portable device further comprises one or more rendering resources. The method comprises generating a multimedia object based on the multimedia content, associating a format handler with the multimedia object, and controlling a selected rendering resource using the format handler to render the multimedia content from the multimedia object.

In another embodiment, a multimedia system is provided for rendering multimedia content in a portable device having an embedded processor. The portable device comprises one or more rendering resources. The multimedia system comprises create media logic that operates to generate a multimedia object based on the multimedia content. The system also comprises selection logic that operates to associate a format handler with the multimedia object. The system also comprises format handling logic that operates to control a selected rendering to render the multimedia content from the multimedia object.

In another embodiment, a computer-readable medium is provided that comprises computer-executable instructions for rendering multimedia content in a portable device having an embedded processor. The portable device further comprises one or more rendering resources. The instructions when executed perform a method that comprises generating a multimedia object based on the multimedia content, associating a format handler with the multimedia object, and controlling a selected rendering resource using the format handler to render the multimedia content from the multimedia object.

In another embodiment, a multimedia system is provided for rendering multimedia content in a portable device having an embedded processor. The portable device further comprises one or more rendering resources. The multimedia system comprises means for generating a multimedia object based on the multimedia content. The system also comprises means for associating a format handler with the multimedia object. The system also comprises means for controlling a selected rendering resource using the format handler to render the multimedia content from the multimedia object.

Other aspects, advantages, and features of the present invention will become apparent after review of the hereinafter set forth Brief Description of the Drawings, Detailed Description of the Invention, and the Claims

### BRIEF DESCRIPTION OF THE DRAWINGS

The foregoing aspects and the attendant advantages of the embodiments described herein will become more readily apparent by reference to the following detailed description when taken in conjunction with the accompanying drawings wherein:

FIG. 1 illustrates a data network that includes a portable wireless device with an embedded controller suitable for implementing one embodiment of a multimedia system to render multimedia content;

FIG. 2 shows a functional block diagram illustrating one embodiment of the portable device of FIG. 1 that includes one embodiment of a multimedia system that operates to render multimedia content;

FIG. 3 shows a detailed block diagram of one embodiment of the multimedia system of FIG. 2;

FIG. 4 shows one embodiment of a state machine managed by a format handler to render multimedia content; and

FIG. 5 shows one embodiment of a method for rendering multimedia content in a portable device.

### DETAILED DESCRIPTION

The following detailed description describes a multimedia system, including methods and apparatus, for rendering multimedia content in a portable device. In one or more embodiments, the portable device has an embedded controller and limited resources (i.e., limited memory capacity), and the system operates to render multimedia content using the available rendering resources of the device.

In one or more embodiments, the multimedia system interacts with a runtime environment executing on the device that is used to simplify operation of the device, such as by providing generalized calls for device specific resources. One such runtime environment is the Binary Runtime Environment for Wireless™ (BREW™) software platform developed by QUALCOMM, Inc., of San Diego, Calif. In the following description, it will be assumed that the multimedia system is implemented on a portable device executing a runtime environment, such as the BREW software platform. However, one or more embodiments of the multimedia system are suitable for use with other types of runtime environments to render multimedia content on a portable device.

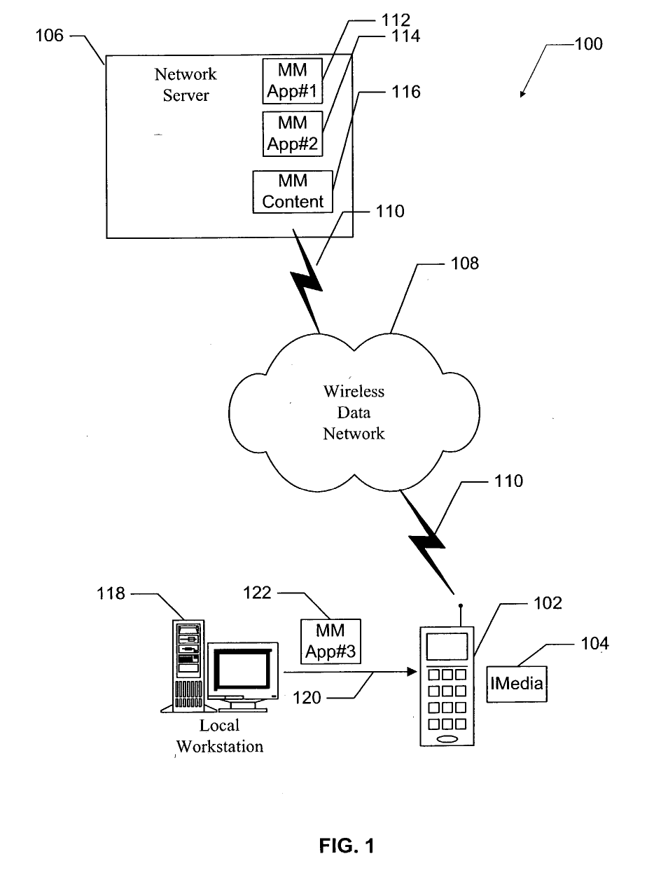

FIG. 1 illustrates a data network 100 that includes a portable wireless device 102 with an embedded controller suitable for implementing one embodiment of a multimedia system to render multimedia content. For example, the device 102 comprises one embodiment of a multimedia system 104 that will hereinafter be referred to as “IMedia.” In the network 100, the wireless device 102 communicates with a network server 106 over a wireless network 108 using wireless communication channels 110.

In one embodiment, the device 102 comprises a cellular telephone that may transmit and/or receive voice information over the wireless network 108. However, one or more embodiments of the described multimedia system are suitable for use with other types of portable devices. For example, other suitable portable devices include, but are not limited to, PDAs, email devices, pagers, tablet computers, mobile telephones or virtually any other type of portable device that includes multimedia-rendering resources.

The device 102 may also receive multimedia applications or content over the wireless network 108. For example, multimedia applications 112 and 114 may be downloaded to the device 102 from the network server 106. Additionally, multimedia content 116 may also be downloaded to the device 102 from the network server 106. It is also possible to download multimedia applications or content to the device 102 from any other network entity coupled to the wireless network 108.

In one embodiment, the device 102 also couples directly to a local system, such as a local workstation 118, via a direct link 120. In one embodiment, the local workstation 118 downloads multimedia applications or content to the device 102 using the direct link 120. For example, the multimedia application 122 is downloaded to the device 102 from the workstation 118 using the link 120.

The IMedia system 104 may be downloaded from the server 106 to the device 102 and operates on the device 102 to render multimedia applications or content. In another embodiment, the IMedia system 104 may be downloaded to the device 102 from the workstation 118 via the link 120, or may be installed in the device during manufacture.

In one embodiment, the IMedia system 104 is provided on a computer readable media, such as a floppy disk, and is loaded onto the system 118 for transmission to the device 102. In another embodiment, the IMedia system 104 may be stored on a computer readable memory device, such as a memory card (not shown), and plugged directly into the device 102, so that the IMedia system 104 may execute on the device 102. Thus, the device 102 may receive the IMedia system 104 in a wireless transmission, a wired transmission, or by retrieving it directly from a memory device.

The network 100 may also include other types of portable devices, such as other types of wireless and non-wireless portable devices, and these devices may communicate with the server 106 or any other network entities utilizing various network types and communication architectures, including wireless and non-wireless networks, private and public networks, switched and non-switched networks, direct links and any combination thereof to download one or more embodiments of the IMedia system 104 to render multimedia content.

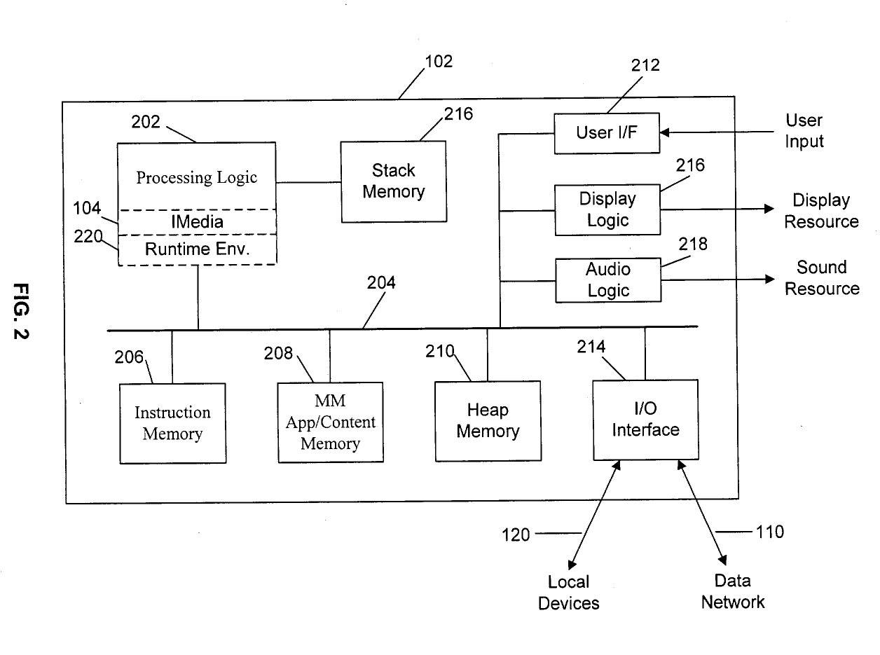

FIG. 2 shows a functional block diagram illustrating one embodiment of the device 102 that includes one embodiment of the IMedia system 104 that operates to render multimedia content. The device 102 comprises processing logic 202 that is coupled to an internal data bus 204 and a stack memory 216. Also coupled to the internal data bus 204 are instruction memory 206, multimedia application/content memory 208, heap memory 210, user interface 212, display logic 216, audio logic 218, and input/output (I/O) interface 214.

During operation of the device 102, the processing logic 202 executes program instructions stored in the instruction memory 206 to generate a runtime environment 220. The runtime environment 220 may be the BREW environment or other suitable runtime environment. To assist with instruction execution, the processing logic 202 utilizes the stack memory 216 to store program data or instructions on a temporary basis. For example, the processing logic 202 may store constants, variables, program addresses, pointers, instructions or other information items on the stack memory 216. In another embodiment, the processing logic 202 may store information on a temporary basis in the heap memory 210. The heap memory comprises virtually any type of memory suitable for the storage and retrieval of information by the processing logic 202.

In one or more embodiments, the processing logic 202 comprises a CPU, gate array, hardware logic, software, or a combination of hardware and software. Thus, the processing logic 202 generally comprises logic to execute machine-readable instructions.

The instruction memory 206 comprises RAM, ROM, FLASH, EEROM, or any other suitable type of memory, or a combination thereof. In one embodiment, the instruction memory 206 is located internal to the device 102, and in another embodiment, the instruction memory 206 comprises a removable memory card or memory device that may be selectively attached to the device 102, and thereby couple to the internal bus 204. Thus, the instruction memory 206 may comprise virtually any type of memory that is capable of storing instructions that may be executed by the processing logic 202.

The user interface 212 receives user input, for example, from a keypad, pointing device, touch pad, or other input mechanisms to allow a user to interact with the device 102. The display logic 216 comprises logic to output information to a device display. For example, the device may include an LCD, LED or other type of display resource. The audio logic 218 comprises logic to output audio information to a device speaker(s), remote speaker(s) or audio system, or other type of sound resource. For example, a pair of remote speakers may receive the output of the audio logic 218 to render audio information to a device user. Thus, the display logic 216 and the audio logic 218 may comprise hardware and/or software in any combination to allow the device 102 to render visual or audio information to the device user.

The I/O interface 214 operates to transmit and receive information between the device 102 and external devices, systems, and/or networks. For example, in one embodiment, the I/O interface 214 comprises a radio transceiver circuit (not shown) that operates to transmit and receive information over a wireless data network using, for example, communication link 106. For example, the transceiver comprises circuitry that modulates information received from the processing logic 202 and converts the modulated information into high frequency signals suitable for wireless transmission. Similarly, the transceiver also comprises circuitry to convert received high frequency communication signals into signals suitable for demodulation and subsequent processing by the processing logic 202.

In another embodiment, the I/O interface 214 comprises a transceiver that operates to transmit and receive information over a hardwired communication link, such as a telephone line, to communicate with a remote system on a public data network, such as the Internet.

In still another embodiment, the I/O interface 214 comprises circuitry that operates to communicate with local devices, such as the local workstation 116 using the link 120. The I/O interface 214 may also include circuitry (such as serial or parallel port logic) to communicate with a printer or other local computer or device, such as floppy disk or memory card. Thus, the I/O interface 214 may comprise any type of hardware, software, or combination thereof to allow the device 102 to communicate with other local or remotely located devices or systems.

During operation of the device 102, execution of program instructions by the processing logic 202 causes the IMedia system 104 to be generated. For example, IMedia instructions that when executed generate the IMedia system 104 may be stored in the instructions memory 206. The IMedia system 104 interacts with the runtime environment 220 to render multimedia applications and content on the device 102. For example, multimedia applications and content may be downloaded to the device 102 via the wireless network 108 and stored in the memory 208. In one embodiment, the IMedia system 104 retrieves the multimedia content stored in the memory 208 via the internal bus 204 and processes the content to render it on the device 102 by interacting with the device's rendering resources (i.e., display logic, audio logic, etc.) via the runtime environment 220. The IMedia system 104 also operates to process and render streaming multimedia content. For example, streaming multimedia content downloaded from the network 108 to the device 102 is rendered on the device 102 using the IMedia system 104.

It should be noted that the configuration of the device 102 is just one configuration suitable for implementing one embodiment of the IMedia system 104 to render multimedia applications and content. It is also possible to implement the IMedia system 104 using other devices or device configurations within the scope of the present invention.

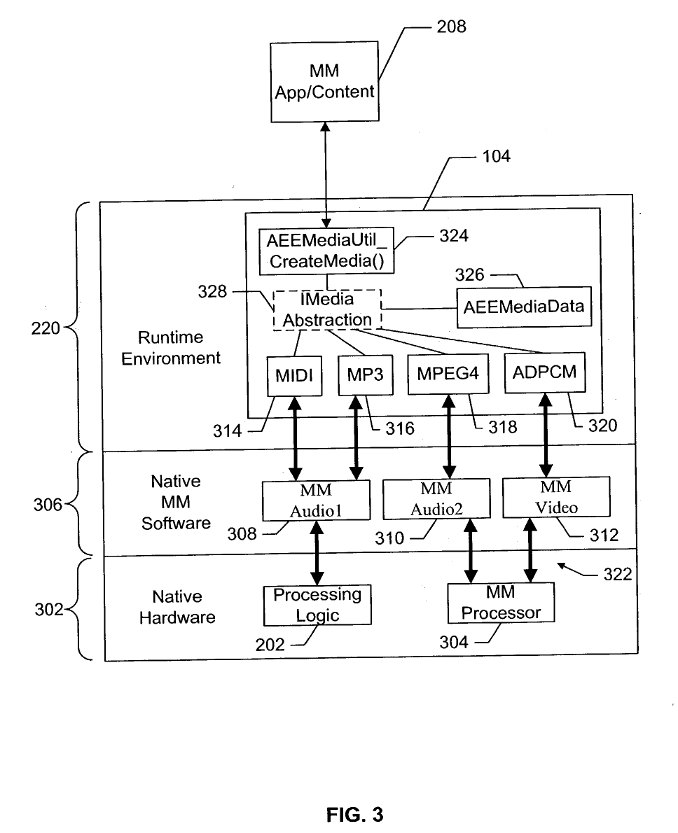

FIG. 3 shows a detailed block diagram of one embodiment of the IMedia system 104 for use in the device 102. The device 102 includes native hardware 302 that comprises processing logic 202 and may optionally include a multimedia processor 304 that is specifically designed to process multimedia information. It will be assumed without further description that the native hardware 302 includes logic to operate the device's rendering resources (i.e., display logic 216, etc.) and that the processing logic 202 and the multimedia processor 304 may operate to control these resources.

The device 102 also includes native multimedia software 306 that comprises audio1 308, audio2 310 and video 312 modules. These modules represent low-level software modules that are used to directly communicate with the native hardware 302 to control selected rendering resources. For example, the video module 312 communicates with the multimedia processor 304 to control video rendering resources. Although one embodiment is shown, it is also possible to have fewer or more multimedia software modules 306 and these modules may communicate with all types of native hardware 302. Thus, other native hardware 302 and software 306 configurations are possible within the scope of the invention.

During operation, the device 102 executes program instructions to generate the runtime environment 220, which in one embodiment, is the Brew environment. It is then possible to execute the IMedia instructions to generate the IMedia system 104 to render multimedia content in conjunction with the runtime environment. For example, the IMedia instructions may be downloaded to the device via the wireless network 108 and stored in the instruction memory 206.

The IMedia system 104 operates to abstract multimedia content handling and define a framework of multimedia interfaces. In one embodiment, the IMedia system 104 operates to provide the following features.

1. Provides generic and easy access to device multimedia features and capabilities.

2. Shields complex application specific integrated circuit (ASIC) level multimedia APIs and resource management.

3. Provides building blocks to develop complex multimedia applications.

4. Optionally derives media type based on file extension, file content, or a signature in file.

The IMedia system 104 includes a create media utility 324, media data structure 326, and format handlers 314, 316, 318, and 320. Also shown as part of the IMedia system 104 is an IMedia abstraction 328, which illustrates a basic IMedia object that is created during operation of the IMedia system 104. A detailed description of the components of the IMedia system is provided as follows.

IMedia Abstraction

The IMedia abstraction 328 is an abstract interface enabling registration and handling of a multimedia content type. The IMedia abstraction 328 maintains a reference to media data in the media data structure 326.

Media Data Structure

The media data structure 326 operates to encapsulate the media data source or sink. This allows the IMedia system 104 to stream media data from or to various sources or destinations. In one embodiment, the media data structure 326 is formed from data structure logic that comprises the processing logic 202 executing program instructions to generate the media data structure 326 in the memory 210.

Create Media Utility

The create media utility 324 performs several functions. First, the create media utility 324 operates to receive multimedia applications or content for rendering. For example, the multimedia applications or content may be stored in the memory 208, and this content includes a function call to the create media utility 324. Second, the create media utility 324 processes the multimedia content to create an IMedia object 328 based on the information contained in the media data 326. After creating the IMedia object, it sets the media data and places the IMedia object in the ready state. In one embodiment, the create media utility 326 is formed from create media logic that comprises the processing logic 202 executing program instructions to create the IMedia object 328 in the memory 210 and perform the functions of the create media utility described herein.

In one embodiment, the create media utility 326 includes selection logic that comprises the processing logic 202 executing program instructions to select a format handler to associate with the IMedia object 328 and perform other functions described herein. For example, the selection logic evaluates the data structure 326 associated with the media content to determine which format handler to select.

Format Handlers

In one embodiment, the IMedia system 104 comprises a collection of format handlers (FH). For example, the IMedia system 104 comprises MIDI 314, MP3 316, MPEG4 318, and ADCPM 320 format handlers. These format handlers provide interfaces 322 between IMedia objects 328 and the multimedia rendering hardware and software of the device 102. In one embodiment, the format handlers interpret a common instruction set so that multimedia applications or content may utilize the same instructions to instruct the format handlers to perform similar tasks, such as play, stop, rewind, etc. Any number of format handlers may be used, and new format handlers may be added to render new types of multimedia content. In one embodiment, the format handlers are formed from format handling logic that comprises the processing logic 202 executing program instructions to perform the functions of the format handlers described herein.

In one embodiment, a common instruction set instructs the format handlers to render multimedia content and provides a mechanism for passing parameters and status. A sample of the instructions included in the common instruction set is as follows.

| | | |
|---|---|---|
| 1. | IMedia_SetMediaParm( ) | ;sets parameters of the FH |
| 2. | IMedia_GetMediaParm( ) | ;gets parameters from the FH |
| 3. | IMedia_SetMediaData( ) | ;sets media data |
| 4. | IMedia_GetMediaData( ) | ;gets media data |
| 5. | IMedia_GetClassID( ) | ;gets class ID |
| 6. | IMedia_GetState( ) | ;gets state |
| 7. | IMedia_RegisterNotify( ) | ;registers a call back with FH |
| 8. | IMedia_Play( ) | ;issues play command to FH |
| 9. | IMedia_Stop( ) | ;issues stop command to FH |
| 10. | IMedia_SetRect( ) | ;set video parameters |

For example, the IMedia_SetMediaParm( ) instruction may be included in the IMedia object to instruct the format handler to set specific parameters, settings, or variables associated with the format handler. For example, parameters associated with a format handler designed to render MPEG video can be set using the IMedia_SetMediaParm( ) instruction. In other embodiments, specific format handlers may also interpret additional instructions (not shown above) that may be included in the IMedia object 328 and that are used to control specific function of the resource being controlled.

In one embodiment, a format handler is software running on the portable device as part of the IMedia system 104. In another embodiment, the format handler may be a combination of hardware and software. Furthermore, format handlers may be added to the IMedia system as they become available so that the IMedia system is extensible and able to render new types of multimedia content as it becomes available.

During operation, format handlers register themselves (their MIME type) with the runtime environment and they can be detected by multimedia applications by querying for the MIME type or enumerating a list of supported (registered) format handlers in the system. Each format handler provides a selection of functions that include, but is not limited to, the following.

1. Providing an application program interface (API) that:

a. Performs playback and recording of multimedia content, including controlling functions such as seek, pause, resume, etc.;

b. Sets and/or Gets audio and video control parameters;

c. Handles asynchronous events from the IMedia object.

2. Sending asynchronous media events via registered callback function.

3. Managing device multimedia rendering resources.

4. Managing a state machine that is extensible by derived classes.

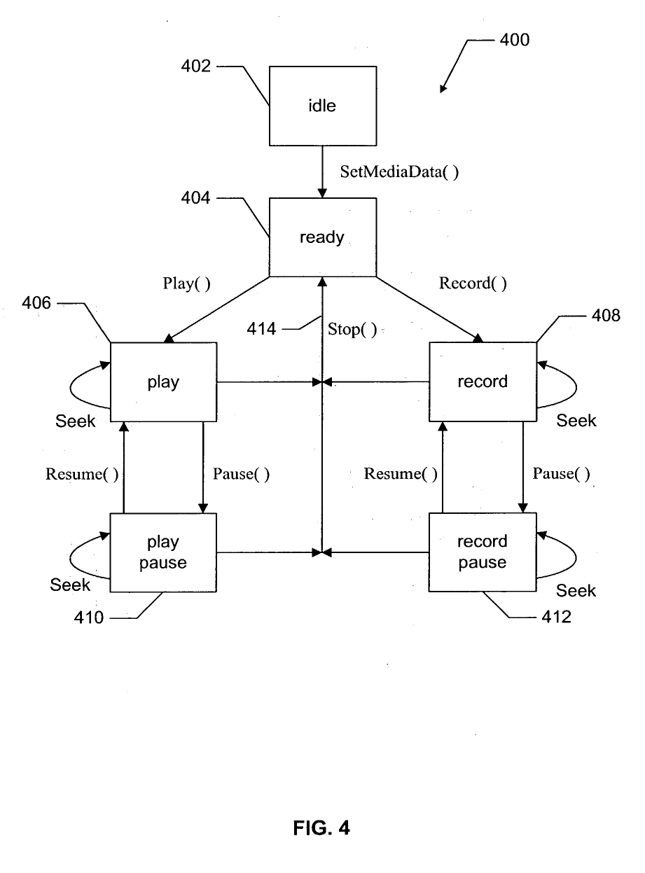

FIG. 4 shows one embodiment of a state machine 400 managed by a format handler to render multimedia content, for example, the format handler 318. The initial state of the format handler is IDLE 402. Once the format handler is associated with an IMedia object, the state of the format handler goes to READY 404. From the READY state 404, the format handler may proceed to either PLAY 406 or RECORD 408 states based on commands associated with the multimedia content. From the PLAY 406 and RECORD 408 states, the format handler may go to PLAY_PAUSE 410 or REC_PAUSE 412 states. From these states, it is also possible to resume the corresponding PLAY 406 and RECORD 408 states. The format handler may also STOP 414 and return to the READY 404 state.

Therefore, using the state machine 400, it is possible for each format handler to control the device's rendering resources to render multimedia applications or content (IMedia object) that has been associated with that formal handler. In another embodiment, it is also possible for the format handler to implement a different state machine than the one shown in FIG. 4. Furthermore, in other embodiments, it is possible to define additional states, which may be used during the rendering process.

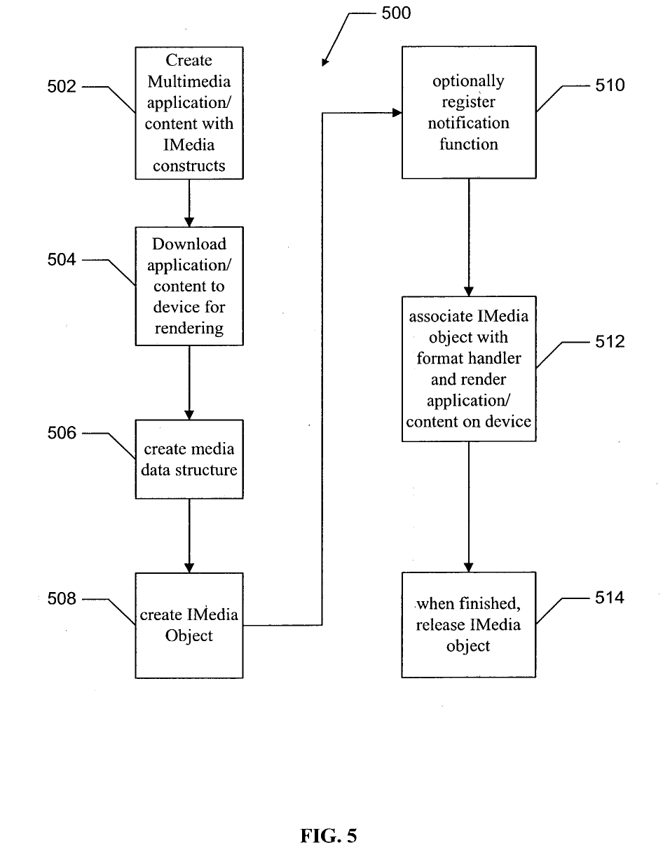

FIG. 5 shows one embodiment of a method 500 for rendering multimedia content in a portable device.

At block 502, a multimedia application or content is created using IMedia constructs so that it may be rendered on a portable device. For example, application developers create IMedia objects using the create media utility 324. The number of IMedia objects and the capabilities, such as simultaneous playback or recording, are dependent on the device. All IMedia objects follow the basic state machine shown in FIG. 4. In one embodiment, the following steps can be used to create and use an IMedia object.

1. Create a media data structure and initialize it based on the media data source/sink. The AEEMediaData is defined as follows.

typedef struct
{

| | |
|---|---|
| AEECLSID clsData; | // Type of media data |
| void * pData; | // Context sensitive data (see table) |
| uint32 dwSize; | // Context sensitive data (see table) |

} AEEMediaData;

2. Initialize the members of the above structure based on the information in the following table.

| clsStream | pData | dwSize | Comments |
|---|---|---|---|
| _FILE_NAME | [symbol] ame | | playback and |
| | | | recording. The file |
| | | | is not opened by |
| | | | IMedia, but the |
| | | | filename is passed |
| | | | sown to the ASIC- |
| | | | level API, which |
| | | | opens the file |
| _BUFFER | Ptr | [symbol] Buffer | playback and |
| | | | recording. The |
| | | | buffer must contain |
| | | | the complete media |
| | | | data. |
| _Source | [symbol] e | Size of data or 0 | [symbol] me streaming |

At block 504, the multimedia content is downloaded to the portable device for rendering. For example, the application or content may be downloaded to the device via the wireless data network 108. The content may be rendered as streaming content, or stored in memory and rendered at a later time.

At block 506, a media data structure is created and initialized based on media source or sink characteristics included in the received content. For example, the media data structure is stored in the media data structure 326. In one embodiment, the media type is derived based on file extension, file content, or a signature included in the file.

At block 508, an IMedia object is created using the associated data structure. For example, the create media utility 324 is used to create the IMedia object. The IMedia object is returned in the ready state 404.

At block 510, an optional step may be performed to register a notification function if it is desirable to received asynchronous events from the IMedia object.

At block 512, the IMedia object is associated with a format handler and the multimedia application or content is rendered on the portable device. For example, the format handler may provide any of the functions of the state machine 400 to render to multimedia content.

At block 514, after the content has been rendered and the IMedia object is no longer needed, it is released.

Implementation Example

The following is an implementation example to illustrate how in one embodiment an IMedia object is created. The example includes references to the corresponding blocks in the method of FIG. 5 and it is assumed that the runtime environment used by the portable device 102 is the BREW environment. Thus, “CApp” is an instance of a BREW applet global structure.

```
  static void App_PlayMedia(CApp * pme)
  {
  int nRet;
  AEEMediaData md;
  // Create Media Data structure (FIG. 5-block 506)
  md.clsData = MMD_FILE_NAME;
  md.pData = (void *)“media/midi_fmt1.mid”;
  md.dwSize = 0;
  // Create the IMedia object and put in Ready state (FIG. 5-block 508)
  nRet = AEEMediaUtil_CreateMedia(pme->a.pIShell, &md, pme-
>m_pIMedia);
  // If successful, register App_MediaNotify( ) as the registered
  callback for IMedia events (FIG. 5-block 510)
  if (SUCCESS != nRet)
    DisplayErrorDlg(pme, IDS_ERR_CREATEMEDIA);
  else if (SUCCESS != IMEDIA_RegisterNotify(pme->m_pIMedia,
  App_MediaNotify, pme))
    DisplayErrorDlg(pme, IDS_ERR_REGISTERNOTIFY);
  else if (SUCCESS != IMEDIA_Play(pme->m_pIMedia)) // Begin the
  playback (FIG. 5-block 512)
  DisplayErrorDlg(pme, IDS_ERR_PLAY);
```

In one or more embodiments included in the present invention, a multimedia system including methods and apparatus operates to render multimedia applications and content on a resource-limited portable device having an embedded controller. Accordingly, while one or more embodiments of the methods and apparatus have been illustrated and described herein, it will be appreciated that various changes can be made to the embodiments without departing from their spirit or essential characteristics. Therefore, the disclosures and descriptions herein are intended to be illustrative, but not limiting, of the scope of the invention, which is set forth in the following claims.

We claim:

1. A method for rendering multimedia content in a portable device having an embedded processor, the portable device further comprising one or more rendering resources, and the method comprising:
generating a multimedia object based on the multimedia content;
associating a format handler with the multimedia object; and
controlling a selected rendering resource using the format handler to render the multimedia content from the multimedia object.

2. The method of claim 1, further comprising generating a multimedia data structure based on the multimedia content.

3. The method of claim 1, wherein the step of controlling comprises:
implementing a state machine in the format handler to control the selected rendering resource; and
rendering the multimedia content using the state machine in the format handler.

4. A multimedia system for rendering multimedia content in a portable device having an embedded processor, the portable device further comprising one or more rendering resources, and the multimedia system comprising:
create media logic that operates to generate a multimedia object based on the multimedia content;
selection logic that operates to associate a format handler with the multimedia object; and
format handling logic that operates to control a selected rendering to render the multimedia content from the multimedia object.

5. The apparatus of claim 4, further comprising data structure logic to generate a multimedia data structure based on the multimedia content.

6. The apparatus of claim 5, wherein the format handling logic comprises:
logic to implement a state machine in the format handler to control the selected rendering resource; and
logic to render the multimedia content using the state machine in the formation handler.

7. A computer-readable medium containing computer-executable instructions for rendering multimedia content in a portable device having an embedded processor, the portable device further comprising one or more rendering resources, the instructions when executed perform a method, comprising:
generating a multimedia object based on the multimedia content;
associating a format handler with the multimedia object; and
controlling a selected rendering resource using the format handler to render the multimedia content from the multimedia object.

8. The method of claim 7, further comprising generating a multimedia data structure based on the multimedia content.

9. The method of claim 7, wherein the step of controlling comprises:
implementing a state machine in the format handler to control the selected rendering resource; and
rendering the multimedia content using the state machine in the formation handler.

10. A multimedia system for rendering multimedia content in a portable device having an embedded processor, the portable device further comprising one or more rendering resources, and the multimedia system comprising:
means for generating a multimedia object based on the multimedia content;
means for associating a format handler with the multimedia object; and
means for controlling a selected rendering resource using the format handler to render the multimedia content from the multimedia object.

11. The apparatus of claim 10, further comprising means for generating a multimedia data structure based on the multimedia content.

12. The apparatus of claim 10, wherein the means for controlling a selected rendering resource comprises:
means for implementing a state machine in the format handler to control the selected rendering resource; and
means for rendering the multimedia content using the state machine in the formation handler.

13. A multimedia system for rendering multimedia content in a portable device having an embedded processor, the portable device further comprising one or more rendering resources, and the multimedia system comprising:
one or more format handlers that operate to control the one or more rendering resources in the portable device; and
a creation utility that operates to create a multimedia object from the multimedia content and associate a selected format handler with the multimedia object, wherein the selected format handler renders the multimedia content from the multimedia object.

14. A method for rendering multimedia content in a portable device having an embedded processor, the portable device further comprising one or more rendering resources, and the method comprising:
encoding the multimedia content with media constructs;
transmitting the multimedia content to the portable device;
generating a multimedia object based on the media constructs;
associating a format handler with the multimedia object; and
controlling a selected rendering resource using the format handler to render the multimedia content from the multimedia object.
